(19) United States
(12) Patent Application Publication
(10) Pub. No.: US 2025/0125447 A1
(43) Pub. Date: Apr. 17, 2025

(54) HEAT PIPE AND BATTERY PACK INCLUDING THE SAME

(71) Applicants: HYUNDAI MOTOR COMPANY, Seoul (KR); Kia Corporation, Seoul (KR)

(72) Inventor: Gungoo LEE, Suwon-si (KR)

(21) Appl. No.: 18/756,695

(22) Filed: Jun. 27, 2024

(30) Foreign Application Priority Data
Oct. 11, 2023 (KR) 10-2023-0134887

(51) Int. Cl. H01M 10/6569; F28D 15/04; H01M 10/613; H01M 10/6552

(52) U.S. Cl. CPC H01M 10/6569; F28D 15/04; H01M 10/613; H01M 10/6552

(57) ABSTRACT

A battery pack includes at least one battery cell including a main body including an electrode assembly, and one or more terminals electrically connected to the electrode assembly, a heat pipe provided adjacent to the battery cell, and a cooling device configured to cool the heat pipe by exchanging heat between a coolant and the heat pipe.

### CROSS-REFERENCE TO RELATED APPLICATION

This application claims priority to and the benefit of Korean Patent Application No. 10-2023-0134887, filed in the Korean Intellectual Property Office, on Oct. 11, 2023, the entire contents of which are incorporated herein by reference.

### TECHNICAL FIELD

The disclosure relates to a heat pipe and a battery pack including the same, and more particularly, to a heat pipe and a battery pack including the same, which are capable of improving heat dissipation performance of a battery cell.

### BACKGROUND

A secondary battery is easy to apply to product groups and has high electrical characteristics such as high energy density. Therefore, the secondary battery is widely used not only for portable devices but also for electric vehicles (EVs) or hybrid electric vehicles (HEVs) driven by electrical driving sources. The rechargeable battery is considered as a new energy source for improving environmentally friendly characteristics and energy efficiency because the rechargeable battery achieves a primary advantage of innovatively reducing the use of fossil fuel, and generates no by-product even though energy is used. Examples of secondary batteries currently used widely include a lithium-ion battery, a lithium-polymer battery, a nickel-cadmium battery, a nickel-hydrogen battery, a nickel-zinc battery, and the like. An operating voltage of a unit secondary battery cell, i.e., a unit battery cell is about 2.5 V to 4.6 V. Therefore, when an output voltage higher than the operating voltage is required, a plurality of battery cells 110 is connected in series and constitutes a battery pack. In addition, the plurality of battery cells is connected in parallel and constitutes the battery pack depending on a charge/discharge capacity required for the battery pack. Therefore, the number of battery cells included in the battery pack may be variously set depending on a required output voltage or a required charging/discharging capacity.

In some cases, in order to configure the battery pack by connecting the plurality of battery cells in series and/or in parallel, generally, a battery module having at least one battery cell is configured first, and then the battery pack is configured by using at least one battery module and adding other constituent elements.

Because a battery pack having a multi-module structure is manufactured such that a plurality of secondary batteries is densely disposed in a small space, it is important to easily dissipate heat generated from the respective secondary batteries. A process of charging or discharging the secondary battery is performed by an electrochemical reaction. For this reason, if heat, which is generated from the battery module during the charging or discharging process, is not effectively removed, the heat accumulates, which may degrade the battery module and cause ignition or explosion in some instances.

Accordingly, a high-output, high-capacity battery module and a battery pack equipped with the battery module needs to be necessarily equipped with cooling devices configured to cool battery cells embedded in the battery module and the battery pack.

### SUMMARY

The present disclosure provides a battery pack capable of effectively discharging heat generated from a battery cell and cooling the battery cell.

A battery pack according to an implementation may include at least one battery cell including a main body including an electrode assembly, and one or more terminals electrically connected to the electrode assembly, a heat pipe provided adjacent to the battery cell, and a cooling device configured to cool the heat pipe based on heat exchange between a coolant and the heat pipe.

In some implementations, the heat pipe may include: an upper plate; a lower plate provided below the upper plate and configured to define, collectively with the upper plate, a chamber filled with a working fluid; a plurality of pillars configured to connect the upper plate and the lower plate; one or more partition walls configured to partition the chamber; and a wick structure provided in the chamber and configured to allow the working fluid to flow in a preset direction, the chamber may be partitioned into a plurality of regions by the partition wall, and the pillars provided in the plurality of regions of the chamber may be different in number.

In some implementations, the number of pillars for each unit area of the regions provided adjacent to the terminals of the battery cell may be larger than the number of pillars for each unit area of the region provided adjacent to the main body.

The terminals may be provided at two opposite sides of the main body, the partition walls may be provided as two partition walls and partition the chamber into first to third chambers, the first and third chambers may be provided adjacent to the terminals, and the second chamber may be provided adjacent to the main body.

A heat pipe according to another implementation may include: a main body having a chamber filled with a working fluid; a wick structure provided in the main body; a plurality of pillars provided in the chamber of the main body; and at least one partition wall provided in the chamber, in which the chamber is partitioned into a plurality of chambers by the partition wall, and in which the number of pillars provided in a chamber adjacent to a heat source among the plurality of chambers is different from the number of pillars provided in the remaining chamber.

In some implementations, the number of pillars provided for each unit area of the chamber adjacent to the heat source may be larger than the number of pillars provided for each unit area of the remaining chamber.

According to the implementations, the overall temperature distribution in the battery cells, which are cooled by the heat pipes, may be uniformized, which may prevent the acceleration of local degradation of the battery cell.

Other effects, which may be obtained or expected by the implementations of the present disclosure, will be directly or implicitly disclosed in the detailed description of the present disclosure. That is, various effects expected according to the present disclosure will be disclosed in the detailed description to be described below.

### BRIEF DESCRIPTION OF THE DRAWINGS

Because the drawings are provided for reference to describe exemplary implementations of the present disclosure, the technical spirit of the present disclosure should not be construed as being limited to the accompanying drawings.

FIG. 1 is a conceptual view illustrating an example configuration of a battery pack according to an implementation of the present disclosure.

FIG. 2 is a perspective view illustrating an example configuration of a battery module.

FIG. 3 is an exploded perspective view illustrating the configuration of the battery module.

FIG. 4 is a partial cross-sectional view taken along line “A-A” in FIG. 3.

FIG. 5 is a view illustrating an example configuration of a battery cell.

FIG. 6 is a conceptual view illustrating an example configuration of adjacent battery cells.

FIG. 7 is an exploded perspective view illustrating an example configuration of a heat pipe.

FIG. 8 is a conceptual view illustrating the configuration of the heat pipe.

FIG. 9 is a top plan view illustrating the configuration of the heat pipe.

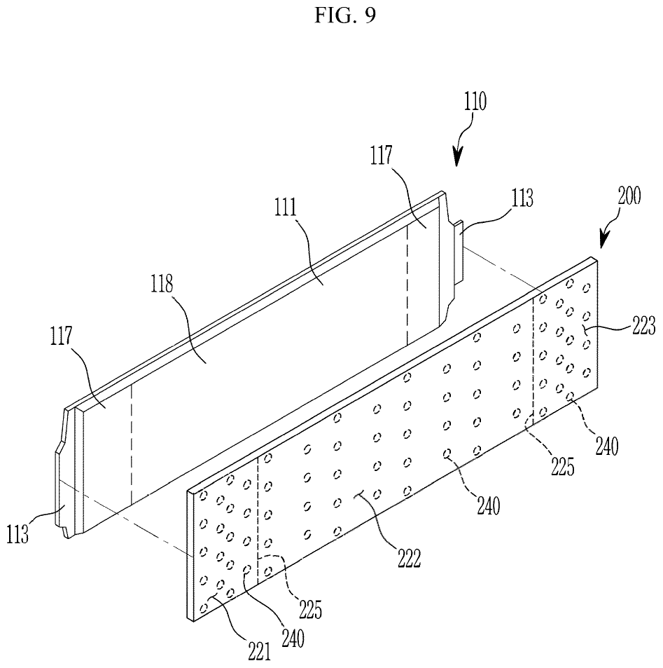

FIG. 10 is a side view illustrating the configuration of the heat pipe.

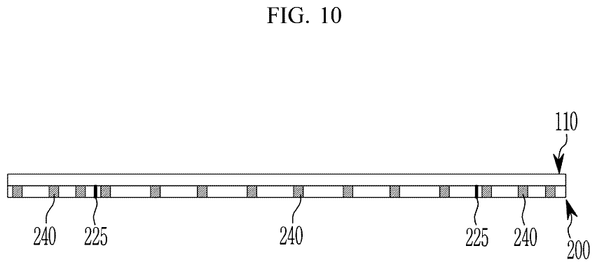

### DETAILED DESCRIPTION

The present disclosure will be described in detail with reference to the accompanying drawings so that those with ordinary skill in the art to which the present disclosure pertains may easily carry out the implementations. However, the present disclosure may be implemented in various different ways and is not limited to the implementations described herein.

Hereinafter, a battery pack according to the present disclosure will be described in detail with reference to the accompanying drawings.

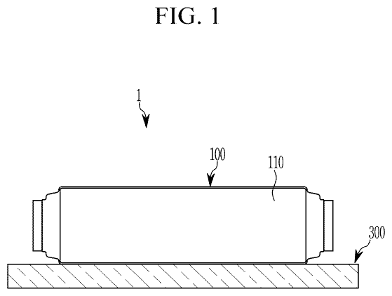

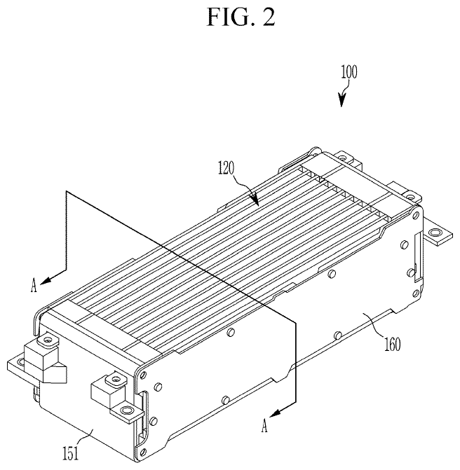

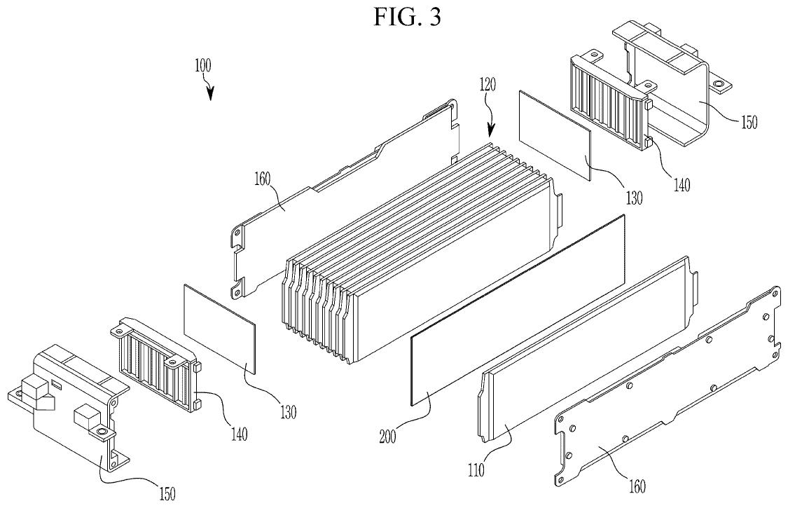

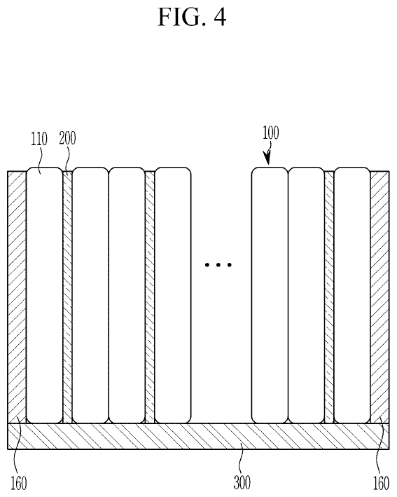

FIG. 1 is a conceptual view illustrating an example configuration of the battery pack according to an implementation of the present disclosure. FIG. 2 is a perspective view illustrating a configuration of a battery module. FIG. 3 is an exploded perspective view illustrating the configuration of the battery module. Further, FIG. 4 is a partial cross-sectional view taken along line “A-A” in FIG. 3.

In some implementations, referring to FIGS. 1 to 4, a battery pack 1 may include a battery module 100 including a plurality of battery cells 110, heat pipes 200 provided adjacent to the battery cells 110, and a cooling device 300.

In the present disclosure, a direction in which the battery cells 110 of the battery module 100 are stacked is defined as a leftward/rightward direction (or an X-direction or a width direction), a direction in which the battery cell 110 extends is defined as a forward/rearward direction (or a Y-direction or a longitudinal direction), and a direction perpendicular to the leftward/rightward direction and the forward/rearward direction is defined as an upward/downward direction (or a Z-direction or a height direction).

The plurality of battery cells 110 may constitute the battery module 100, and the plurality of battery modules 100 may constitute the battery pack 1.

The plurality of battery cells 110, which constitute the battery module 100, may be stacked in a preset direction (e.g., the leftward/rightward direction or the X-direction), and the plurality of battery cells 110 may be connected in parallel and/or in series. The battery cells 110, which constitute the battery module 100, are secondary batteries, i.e., pouch-type secondary batteries. The plurality of battery cells 110 may be stacked on one another to be electrically connected to one another, thereby constituting a battery cell stack 120.

In some implementations, sensing boards 130, busbar frames 140, and sensing covers 150 are disposed at two opposite sides of the battery cell stack 120 based on the forward/rearward direction. In addition, a left endplate 160 and a right endplate 160 are respectively provided at the two opposite sides of the battery cell stack 120, and the left and right endplates 160 support the plurality of battery cells 110.

The busbar frame 140 is disposed between the sensing board 130 and the sensing cover 150 and electrically connect electrode leads 113 of the battery cells 110, such that the plurality of battery cells 110 is connected in series and/or in parallel.

The sensing board 130 may be provided outward of the battery cell stack 120 based on the forward/rearward direction and transmit state information, which includes voltages, electric currents, and temperatures of the battery cells 110, to a battery management system (BMS). The sensing board 130 may be implemented as a printed circuit board (PCB).

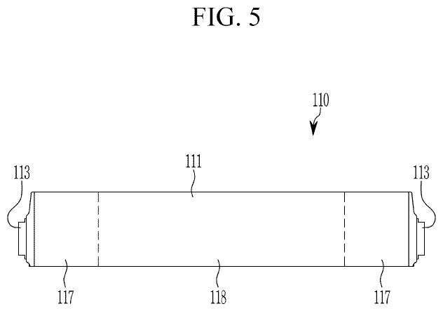

With reference to FIG. 5, the battery cell 110 may include a battery casing 111 configured to accommodate an electrode assembly including a positive plate, a negative plate, and a separator, and the electrode leads 113 protruding from the battery casing 111. The electrode leads 113 may be provided at two opposite sides of the battery casing 111.

The battery cell 110 may be divided into a plurality of regions depending on the positions of the electrode leads 113. In some implementations, the battery cell 110 may be divided into terminals 117 that are regions adjacent to the electrode leads 113, and a main body 118 that is a region excluding the terminals 117 of the battery casing 111.

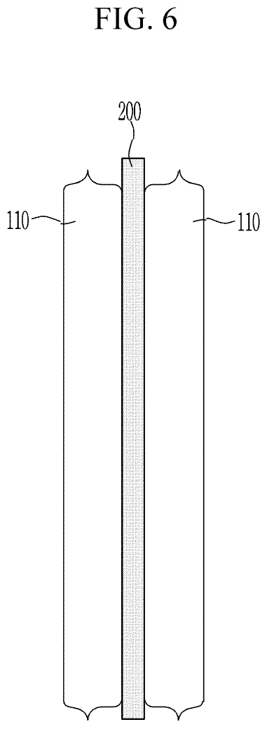

With reference to FIG. 6, the heat pipe 200 is provided between the adjacent battery cells 110. Specifically, the heat pipe 200 may be positioned to be in contact with the battery cell 110.

With reference back to FIG. 1, the cooling device 300 may include a coolant channel positioned below the battery cells in order to cool the battery cells 110. A coolant flows in the coolant channel. In some examples, the cooling device 300 may include a planar structure such as a board, a plate, etc., which define the coolant channel therein. The cooling device 300 may be made of metal. The battery cells are cooled by heat exchange between the heat pipe 200 and the coolant flowing in the coolant channel.

Hereinafter, the configuration of the heat pipe will be described in detail with reference to the accompanying drawings.

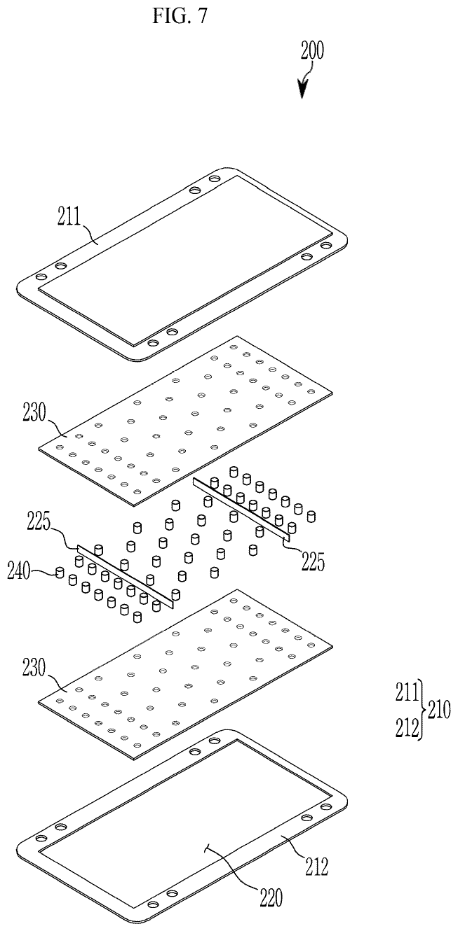

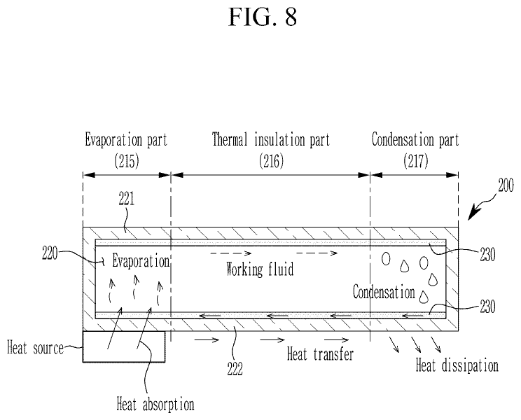

With reference to FIGS. 7 and 8, the heat pipe 200 may include a main body 210 including an upper plate 211 and a lower plate 212, wick structures 230 provided in the main body 210, and pillars 240 configured to connect upper and lower portions of the main body 210. The pillar 240 may be made of copper. The heat pipe 200 refers to a kind of heat exchanger configured to efficiently transfer heat between interfaces of two solids by adopting thermal conductivity and a principle of phase transition.

The upper plate 211 and the lower plate 212 are coupled to be in close contact with each other and define the main body 210, and a chamber 220 is formed in the main body 210. The main body 210 including the upper plate 211 and the lower plate 212 may be made of copper. In the present disclosure, an example is described in which the main body 210 is defined by coupling the upper plate 211 and the lower plate 212. However, the upper plate 211 and the lower plate 212 may be integrated without being distinguished, as necessary, such that the main body 210 may be formed.

The chamber 220 defined in the main body 210 is filled with a working fluid. The working fluid may include at least any one of helium, mercury, sodium, ammonia, alcohol, and water depending on the temperature environment to which the heat pipe 200 is applied.

The wick structures 230 may be provided on an inner surface of a lower portion of the upper plate 211 of the main body 210 and an inner surface of an upper portion of the lower plate 212. In some examples, the wick structure 230 may be manufactured by sintering a porous board, a mesh net, metallic powder, or the like in order to implement capillarity. The working fluid may be moved in a preset direction (e.g., from a condensation part 217 to an evaporation part 215 to be described below) by capillarity implemented by the wick structure 230.

The heat pipe 200 may be divided into the evaporation part 215, the condensation part 217, and a thermal insulation part 216 depending on the process of operating the working fluid. That is, the heat pipe 200 may be divided into the evaporation part 215, the condensation part 217, and the thermal insulation part 216 depending on positions of heat sources that supply heat to the heat pipe 200.

A region, in which the working fluid comes into contact with the heat source and vaporizes, is the evaporation part 215, a region, in which the vaporized working fluid is liquefied, is the condensation part 217, and a region, in which the vaporized working fluid moves from the evaporation part 215 to the condensation part 217, is the thermal insulation part 216. That is, when heat is applied to the evaporation part 215, the working fluid vaporizes, passes through the thermal insulation part 216, and transfers the heat to the condensation part 217. The working fluid is liquefied in the condensation part 217 and flows back to the evaporation part 215 through the wick structure 230. When the series of processes is repeated, the heat from the heat source is transferred, such that the cooling effect is implemented.

In some implementations, one or more partition walls 225 are provided in the chamber 220 in the main body 210, and the chamber 220 is partitioned into a plurality of chambers by the partition walls 225. For example, the partition walls 225 may be provided as two partition walls 225. The three chambers 220 may be defined in the main body 210 by the two partition walls 225.

The pillars 240, which connect the upper and lower portions of the main body 210 (or connect the upper plate 211 and the lower plate 212), are provided in the chamber 220 defined in the main body 210. The upper and lower portions of the main body 210 are connected by the pillars 240. The pillar 240 may be made of copper.

The pillars 240 support the upper plate 211 and the lower plate 212, such that a heat transfer effect between the upper plate 211 and the lower plate 212 may be improved. The chamber 220 between the upper plate 211 and the lower plate 212 may prevent the interior of the main body 210 from being collapsed. In addition, it is possible to improve a heat exchange effect between the working fluid and the heat transferred to the upper plate 211 or the lower plate 212.

The heat pipe is partitioned into the plurality of regions by the partition wall 225 provided in the chamber 220 defined in the main body 210, and the pillars 240 provided in the plurality of regions may be different in number.

In some implementations, the two partition walls 225 may be provided in the main body, and the chamber 220 may be partitioned into a first chamber 221, a second chamber 222, and a third chamber 223 by the two partition walls 225.

The first chamber 221 and the third chamber 223 are regions adjacent to the terminals 117, and the second chamber 222 is a region adjacent to the main body.

The number of pillars 240 provided in the first chamber 221 and the second chamber 222 may be different from the number of pillars 240 provided in the second chamber 222. Particularly, the number of pillars 240 provided in the first chamber 221 and the second chamber 222 may be larger than the number of pillars 240 provided in the second chamber 222.

In other words, a density of the pillars 240 provided in the first chamber 221 and the second chamber 222 may be higher than a density of the pillars 240 provided in the second chamber 222. That is, the number of pillars 240 provided for each unit area of the first chamber 221 and the third chamber 223 may be larger than the number of pillars 240 provided for each unit area of the second chamber 222.

Because the amount of heat generated from the terminals 117 is larger than the amount of heat generated from the main body 118, the first chamber 221 and the third chamber 223 have a relatively larger number of pillars 240 than the second chamber 222. When the number of pillars 240 provided in the first and third chambers 221 and 223 adjacent to the terminals 117 increases, a heat exchange area between the working fluid and the pillars 240 relatively increases. Therefore, heat transfer is quickly performed in the first and third chambers 221 and 223 adjacent to the terminals 117.

In the case of the second chamber 222 in which the number of pillars 240 is relatively small, the heat exchange area between the working fluid and the pillars 240 is relatively small. Therefore, the heat transfer is performed relatively slowly in the second chamber 222 adjacent to the main body 118.

Therefore, a temperature of the terminals 117, which are adjacent to the first and second chambers 221 and 222, and a temperature of the main body which is adjacent to the third chamber 223, are entirely uniformized. Therefore, the overall temperature distribution in the battery cells is uniformized, which may prevent the acceleration of local degradation of the battery cells and extend the lifespan of the battery cell.

Hereinafter, a process of operating the battery pack according to the implementation will be described in detail.

The heat, which is generated from the battery cells by the operation of the battery pack such as the operation of charging and discharging the battery pack, is transferred to the cooling device through the heat pipes 200. The heat transferred to the cooling device through the heat pipe 200 is removed by heat exchange with the coolant.

In this case, the heat generated from the terminals 117 of the battery cell is relatively quickly transferred through the first chamber 221 and the third chamber 223 of the heat pipe 200, and the heat generated from the main body 118 is relatively slowly transferred through the second chamber 222 of the heat pipe 200.

That is, a heat transfer rate in the first and third chambers 221 and 223, in which the number of pillars 240 is relatively large, is higher than a heat transfer rate in the second chamber 222 in which the number of pillars 240 is relatively small. Therefore, the overall temperature distribution in the heat pipe is uniformized, such that the overall temperature distribution in the battery cells is uniformized.

Because the temperature distribution in the battery cells is uniformized as described above, it is possible to prevent the acceleration of local degradation of the terminals 117 and extend the lifespan of the battery cell.

While the implementations of the present disclosure have been described above, the present disclosure is not limited thereto, and various modifications can be made and carried out within the scope of the claims, the detailed description of the disclosure, and the accompanying drawings, and also fall within the scope of the disclosure.

What is claimed is:

1. A battery pack comprising:
at least one battery cell comprising (i) a main body that comprises an electrode assembly and (ii) one or more terminals that are electrically connected to the electrode assembly;
a heat pipe disposed adjacent to the at least one battery cell; and
a cooling device configured to cool the heat pipe based on heat exchange between a coolant and the heat pipe.

2. The battery pack of claim 1, wherein the heat pipe comprises:
an upper plate;
a lower plate that is disposed below the upper plate and defines, with the upper plate, a chamber configured to accommodate a working fluid;
a plurality of pillars that are disposed in the chamber and connect the upper plate to the lower plate;
one or more partition walls that partition the chamber into a plurality of regions; and
a wick structure disposed in the chamber and configured to transfer the working fluid in a preset direction, and
wherein a number of the plurality of pillars provided in one of the plurality of regions of the chamber is different from a number of the plurality of pillars provided in another of the plurality of regions of the chamber.

3. The battery pack of claim 2, wherein the plurality of pillars comprise (i) first pillars that are disposed in a first region among the plurality of regions adjacent to the one or more terminals and (ii) second pillars disposed in a second region among the plurality of regions adjacent to the main body, and
wherein a number of the first pillars per unit area is greater than a number of the second pillars per unit area.

4. The battery pack of claim 3, wherein the one or more terminals comprise a pair of terminals that are disposed at two opposite sides of the main body,
wherein the one or more partition walls comprises two partition walls that partition the chamber into a first chamber, a second chamber, and a third chamber,
wherein the first and third chambers are disposed adjacent to the pair of terminals, respectively, and
wherein the second chamber is disposed adjacent to the main body.

5. The battery pack of claim 2, wherein the wick structure comprises a mesh net.

6. The battery pack of claim 2, wherein the wick structure comprises a board that defines a plurality of pores.

7. The battery pack of claim 2, wherein the wick structure is one of a plurality of wick structures that are disposed in the chamber, and
wherein the one or more partition walls and the plurality of pillars are disposed between the plurality of wick structures.

8. A heat pipe comprising:
a main body that defines a chamber configured to accommodate a working fluid;
a wick structure disposed in the main body;
a plurality of pillars disposed in the chamber of the main body; and
at least one partition wall that is disposed in the chamber and partitions the chamber into a plurality of chambers, and
wherein the plurality of pillars comprise (i) first pillars that are disposed in a first chamber among the plurality of chambers adjacent to a heat source and (ii) second pillars disposed in a remaining chamber among the plurality of chambers,
wherein a number of the first pillars disposed in the first chamber is different from a number of the second pillars disposed in the remaining chamber.

9. The heat pipe of claim 8, wherein the number of the first pillars per unit area is greater than the number of the second pillars per unit area.

10. The heat pipe of claim 8, wherein the wick structure comprises a mesh net.

11. The heat pipe of claim 8, wherein the wick structure defines a plurality of pores.

12. The heat pipe of claim 8, wherein the wick structure is one of a plurality of wick structures that are disposed in the chamber, and
wherein the least one partition wall and the plurality of pillars are disposed between the plurality of wick structures.
